(19) United States
(12) Patent Application Publication
(10) Pub. No.: US 2004/0076724 A1
(43) Pub. Date: Apr. 22, 2004

(54) Method and apparatus for peeling of fruits cut i slides

(76) Inventor: Jan Staehr, Birkeroed (DK)

Correspondence Address: JAN STAEHR, Furesoehave 4A, Birkeroed, 3460, DK

(21) Appl. No.: 10/280,361

(22) Filed: Oct. 21, 2002

(51) Int. Cl. A23P 1/00

(52) U.S. Cl. 426/482

(57) ABSTRACT

Method for peeling of fruits and like shaped foods, where the diameter can vary, and which is cut in slides, and where there a used a cylinder shaped knife-or cutting arrangement (1) which is, variable in the diameter, and which has a unbroken knife bottom diameter, which is spiral shaped or snail shell shaped, and which has an overlapping and holding together knife front. And including an apparatus for peeling of fruits or like shaped foods, where the diameter can be vary, and where there are a cylinder shaped cutting arrangement (1) is without broken, and where the cylinder shaped cutting arrangement (1) is shaped as a spiral or a snail house with overlapping ends, and where it has a press top (2, 2′, 2″), which is placed upper on the cylinder shaped cutting arrangement (1).

The invention relate to a method and an apparatus for peeling of fruits and like shaped foods, where the diameter can be of a various diameter. And where the fruit has been cut in slides, and where one can be used a knife-or cutting arrangement, which is cylindrical shaped.

Hitherto one have used very big complicated peeling apparatus as an example known from patent description no. WO A 9004929. In this patent description is shown a firmed cylindrical cutting aggregate, which has a firm or a fixed diameter. And where there moreover only can be worked whole fruits, as an example oranges or lemons. And where the fruit meet after the separation from the peel, with a piston arrangement, would be pressed out of the firm cylindrical cutting arrangement.

To be able to use above-mentioned arrangement optimum, then it is demanded furthermore that the fruit shall be cut in the bottom as the top. So that the fruit meet do not after the punching with the knife arrangement would have a peel on the top and on the bottom.

The disadvantages by above-mentioned system is therefore that the system only can punch fruits into a firm or permanent diameter, so that there must be very large waste of the cut or punched fruit.

A further disadvantage by above-mentioned apparatus is also that it demand a supplying arrangement, where the bottom and the top of the fruit can be cut parallel with each other. And after this demands the cutting arrangement unit furthermore an apparatus or a special arrangement for turning to the right direction of the fruit in proportion to the cutting apparatus, so that the top get turned the open fruits meet side against the knife arrangement.

Hitherto one have also often, when one as an example have to use cut lemon slices in his/hers drinks, used to cut the peel off with a normally knife, to avoid rests in the drink of the spray means there possibly might be on the outer of the lemon peel.

This operation with following to cut the peel of has often been a very difficult or a stiff operation. And the cutting operation itself has often should be done over more tempi.

The new by the invention is that one by using a special knife-arrangement there is gliding variable in its the diameter, and a holding-and punching arrangement for the same, can establish an apparatus in different variants, which can be worked or operated mechanical for removing of the peel from the slice cutting fruits as an example lemon, orange and like, with different diameter. And where one in the same arrangement further has means for easy to be able to remove the outer shell or peel from the rest of the subject or here the actually fruit.

This can be obtained according to the invention by a method of this in the beginning mentioned sort, there is characteristic of that one use a knife arrangement, with a variable diameter, and which has an unbroken knife diameter, which is spiral shaped or like snail shelled shaped. And which has an overlapped compared knife front.

And where the apparatus of the beginning mentioned sort is characteristic of that the knife blade of the cylindrical shaped cutting arrangement is without break. And where the cylindrical shaped cutting arrangement is shaped as a spiral or a snail shell with overlapping ends. And that a pressing top is placed on the cylindrical cutting arrangement.

The generally working way of the cutting apparatus in an embodiment as just mentioned has shown by using of the cylinder shaped and spiral shaped knife arrangement. As one in a manually embodiment with a conical counter-hold stop, only lover the unit down over a cut lemon slide.

After this one press easy or soft down over the lemon slide, to the spiral shaped knife generally has the same diameter as the inner part of the shell of the lemon slide. And after which the knife arrangement with the fingers have to be hold in this position, as one after this then press the knife front through the lemon slide.

After this one generally get off with the position holding fingers, and press further. After which the cut lemon slide has to be pressed/thrown from the lemon meet, by the conical top has to be pressed longer down in the spiral cylinder knife. And this position has to be hold with the fingers.

After this has the shell to be lid away from the meet to the wanted refuse place or like. And one let go the counter-hold part of the knife against the conical top, by which the spring arrangement of the knife arrangement would be smaller, and the shell will get off and leave the knife arrangement.

There has to be obtained a plain or single cutting unit, with which one with only one hand very easy can peel as an example lemon slides or other fruits with different diameter. And generally only by one working operation.

Where working operation.:—The diameter changing of the knife, cutting off of the shell, separating of the shell from the fruit meet, and transport and lifting of the shell and finally get away of the shell, can be done generally in one fluent and connected working operation.

In a specially embodiment for the apparatus for peeling according to the invention can the pressure part for the cutting spiral consist of a cone/conical shaped part, which conical tip or end is going down in the inner of the knife arrangement. And where the side of the conical top by pressing down change the diameter of the knife arrangement.

And that one by chosen of the right angle of the cone and the material friction after this by manually influence can hold the chosen diameter by pressing the cone down in the spiral shaped knife, and then obtain a gliding changing of the diameter of the knife.

When the chosen diameter is obtained, then will this be able to be hold, so that one get so much fruit meet with of the slide cut fruit as possible. When one has obtained counter hold or the bottom, and continue with pressing the top down in the knife, then obtain one further to be able to expand or remove the shell from the fruit meet in such a way that one can lifted the shell away from the fruit meet, without that the meet are going to following up with the lemon shell.

In another embodiment of the apparatus according to the invention can the top of the knife arrangement be designed as a cylinder shaped and split pressing top, with press/holding legs for manually changing of the diameter of the knife arrangement. And where some of the legs in the arrangement further as an example could be equipped with a pressure/finger grips.

One obtain by this that the diameter on the knife arrangement gliding and variable would be able to change. And if this split pressure top in the same time is springy in its legs, then obtain one only by partly to let grip on the legs, after that one have cut through the fruit slide and the shell that the cut shell automatically would be removed from the cut fruit meet. And one can now only lift the knife arrangement away with the shell fixed on this, for laying off the cut shell.

In a further embodiment according to the invention, then can the top of the knife apparatus consist of a cylinder shaped pressure part, which is placed in the inner of the knife arrangement. And which can be made of a compressing holding material, as an example foam rubber or like material. And the cylinder shaped pressure part can again indirect be fixed or hold to a top plate, which again rest on the upper edge of the knife arrangement.

One obtain by this that the top and the pressure arrangement or the plate itself can be hold or connected to the knife arrangement even when the knife diameter has to be changed.

The invention shall after this be explained nearer in the following under reference to the drawings, where

FIG. 1 shows an example on an ideal embodiment of the peeling apparatus seen in perspective. And where the apparatus generally consist of an lower knife part 1 with an “ad hoc” variable knife diameter, and an upper pressure part 2, 2′, 2″ for pressing down changing of the knife diameter.

The knife part 1 is shaped as a spiral twisted cylinder, with over lapping knife ends. Where one, with a upper conical top part 2, by pressing down with the hand on this,-can change the knife diameter, namely in such a way that this fit in diameter to/for peeling of the actually size shell 4.

After this has one to press down with the fixed and founded diameter, the knife 1 down to cut off of the shell.

When one so has cut off the shell, then will a continuing pressing down of the conical top 2 cause that the cutting through shell 4 now automatically in one working operation has to be thrown or split from the fruit meet 3.

The knife unit 1 and 2 has now to be lifted in the same working operation from the peeled fruit meet 3 with the shell/peel 4, which now is sitting on the knife 1, and has to be guided to that place, where one want this to be placed.

After this can one slack off with the finger grip or the counter hold on the sides of the knife 1.

And the pressure top 2 will now respectively by springy force of the spiral twisted knife or the force of the contraction, or even by an extra arrangement of holding together 5, as an example an arrangement of drawing spring ideally placed in the middle of the cutting unit,-automatically reduce the diameter of the cylinder knife 1. And by which the shell 4 leave from the knife unit 1, for momentary throw off to or on the wanted place.

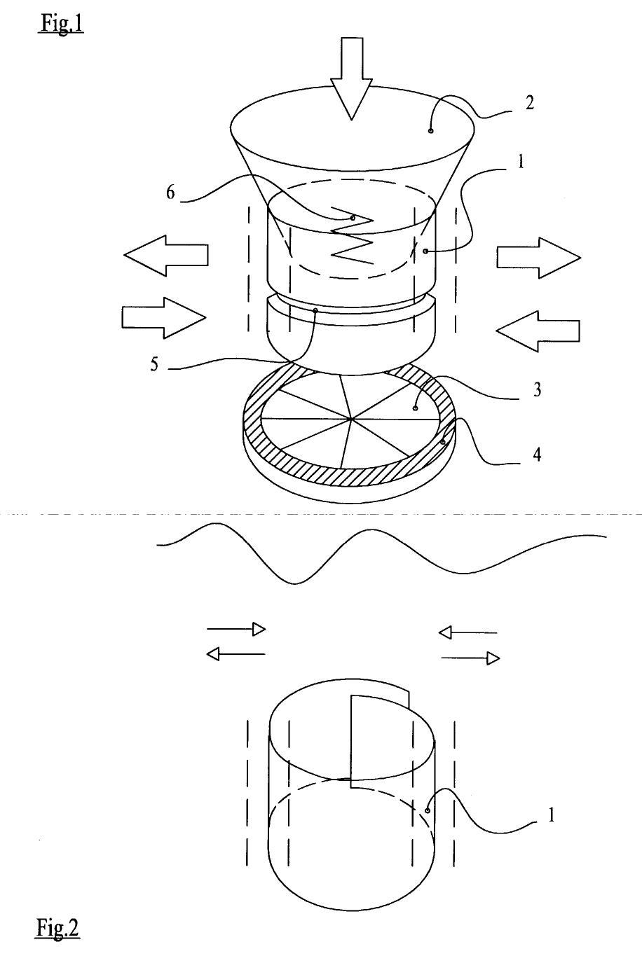

FIG. 2 shows in perspective a spiral twisted knife 1, where it here is shown that the cylinder diameter of the knife column “ad hoc” can be variable.

An ideal embodiment for this knife arrangement 1 would be, if it, in its embodiment, was springy, in such a way that it was the shape of the spiral, which was an arrangement of spring.

The overlapping sides on the cylinder knife 1 should go tight of each other, in such a way that the edge here could made a generally compact cutting edge for this part or this section.

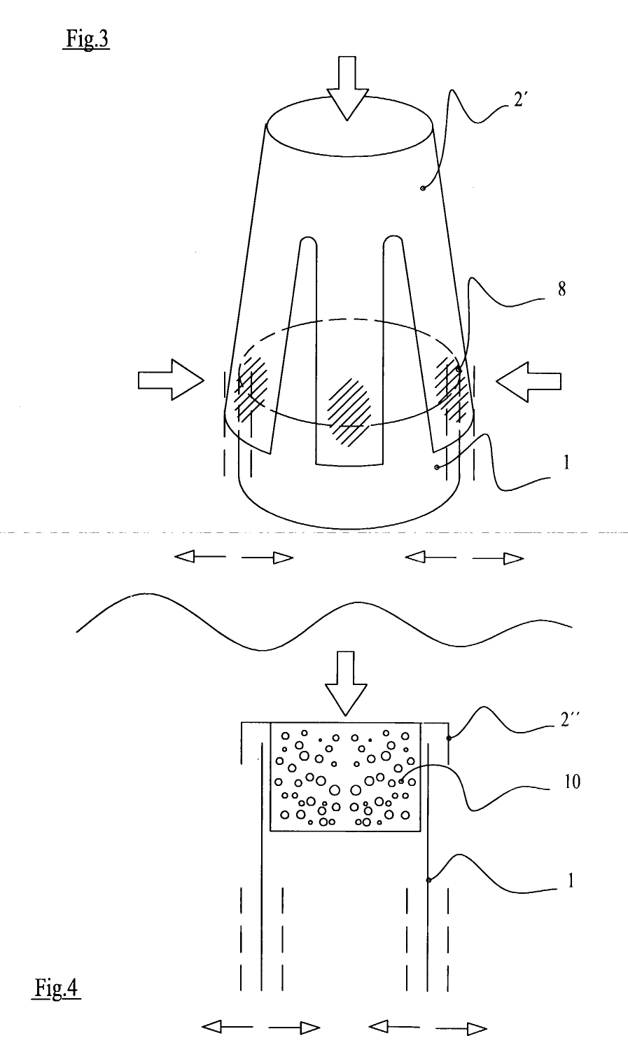

FIG. 3 shows in perspective an arrangement of knife 1, where the top is shaped as a split press-top 2′, and where one down on the end of the legs generally fluent has fixed a spiral knife arrangement 1.

When one serve the knife arrangement 1, so shall one with the fingers press the flaps on the top together, so that the knife spiral 1 change its diameter With the present arrangement would the biggest diameter on the arrangement of the knife 1 be the start diameter.

By the start shall one press the spiral knife 1 together for the wanted actually diameter.

Knife 1 can ideal be fixed to the flaps on the pressure part of the top 2′ by a hasp arrangement as known from circular saws.

On the side itself and outer on some of the flaps there could also ideally be placed finger grips 8 in different, but for the purpose, ideally shaped arrangements 8.

FIG. 4 shows in section a third ideally embodiment of the apparatus according to the invention, consist of a spiral shaped knife arrangement 1 and a press-top 2″. Here are one also starting up with the big diameter, as mentioned under FIG. 3. As one, by pressing together with the fingers, can fit the diameter for the wanted diameter, and matching to the cut slice, where one want the shell 4 to be taken off.

The arrangement consist generally here of only two parts 1 and 2″. Namely a cylinder shaped and spiral twisted knife 1, which is springy. And where one then have a press top 2″. Where there here are integrated a holding and a expansion arrangement 10. Here ideally establish via as an example a foam rubber plug 10, which is fixed generally to the top 2″ on the inner side of this.

The equipment 1 and 2″ will here be easy to separate, as the top 2″ and the springy plug 10 has to be drawn out of the top of the cylinder spring 1, and after this can the two or tree parts 1, 2″ and 10 be washed and be cleaned.

To be able to fix the plug of foam rubber 10, so could it be fixed with a stag through the plug 10. Where the stag then was fixed or integrated to the top itself 2″.

The stag could in itself also be an arrangement of screws or like, where one then fixed the plug 10 between.

1. Method for peeling of fruits and like foods, where the fruit is cut in slides, and where the diameter can be variable, and where there are used a cylinder shaped cutting aggregate, which is variable in the diameter, as an example in an embodiment with an unbroken spiral shaped knife bottom diameter or like variable arrangement, characteristic of, that an unbroken spiral shaped knife (1) or a cutting arrangement (1) is equipped with a multifunctional means (2) consist of only one part, and where this means (2) for the first is centred on the centreline of the cylindrical knife (1) and for the second in the same time is placed or put into top part of the knife (1), and where this means (2), in this position, namely have means there can guide and vary a different sizes diameter of cuttings, and in the same time and in this means itself (2) also have means for a pressing and holding function on the multifunctional means (2), and specially with only one hand for operating or ideal peeling of lemon fruits (4) and like (4).

2. Apparatus for peeling of fruits according to claim 1, characteristic of, that the pressure part for the spiral shaped cutting arrangement consist of a cone/conical shaped part (2), which conical tip is going down in the inner of end of the counter hold of arrangement of the knife (1), and where the side of the conical top (2) by pressing down change the diameter of the cutting arrangement (1), and by choosing of the right angel of the cone and the right material friction after this by manually influence to be able to keep the hold chosen diameter.

3. Apparatus for peeling of fruits according to claim 2, characteristic of, that the spiral shaped knife arrangement (1) can be springy, and in addition to that can have integrated means (5) for holding together the spiral (1) as an example shaped as a round going holding/guiding not.

4. Apparatus for peeling of fruits according to claim 2, characteristic of, that top (2) and the knife arrangement (1) can have integrated means (5) for mutual stick together as an example made via an arrangements of spring (6), which can be placed in the middle or in the bottom of the top (2).

5. Apparatus for peeling of fruits according to claim 2, characteristic of, that the press top can be shaped as a split cylinder shaped press top (2′), with press/hold legs for manually changing of the diameter of the knife arrangement, and that some of the legs as an example further could be equipped with ideally press/finger-grips (8).

6. Apparatus for peeling of fruits according to claim 2, characteristic of, that the press top can consist of a cylinder shaped press part (2″ and 10) placed in the inner of the knife arrangement (1), and can be of a compressed holding material (10) as foam rubber or like material, and that this (1) generally is or can be fixed to the top.
